(19) United States
(12) Patent Application Publication
(10) Pub. No.: US 2011/0298764 A1
(43) Pub. Date: Dec. 8, 2011

(54) METHOD AND DEVICE FOR AUTOMATICALLY CONTROLLING LUMINANCE OF DISPLAY UNIT

(75) Inventor: Jung Su HA, Hwaseong-si (KR)

(73) Assignee: SAMSUNG ELECTRONICS CO. LTD., Suwon-si (KR)

(21) Appl. No.: 13/110,367

(22) Filed: May 18, 2011

(30) Foreign Application Priority Data
Jun. 4, 2010 (KR) 10-2010-0052815

(51) Int. Cl. G06F 3/038; G09G 3/32

(52) U.S. Cl. 345/207; 345/82

(57) ABSTRACT

A method and an apparatus for displaying and controlling a screen of a portable terminal device are provided. The apparatus includes a sensor for detecting illumination according to peripheral brightness, and a display unit for outputting display data of the portable terminal device, for storing gamma register values corresponding to luminance data, for displaying the display data on a screen, for converting the detected illumination into luminance, and for selecting a gamma register value corresponding to the luminance to control the brightness of the screen.

### PRIORITY

This application claims the benefit under 35 U.S.C. §119(a) of a Korean patent application filed on Jun. 4, 2010 in the Korean Intellectual Property Office and assigned Serial No. 10-2010-0052815, the entire disclosure of which is hereby incorporated by reference.

### BACKGROUND OF THE INVENTION

1. Field of the Invention

The present invention relates to a control device and a control method of a display unit. More particularly, the present invention relates to a device for automatically controlling the luminance of a display unit with low power, and a method thereof.

2. Description of the Related Art

In general, a device with a Light Emitting Diode (LED) and a Liquid Crystal Display (LCD) has a function for controlling the brightness of a display unit. For example, in a terminal using an Active Matrix Organic LED (AMOLED), a controller detects the luminance displayed on the LED to control the luminance of the display unit.

FIG. 1 is a block diagram illustrating a configuration of a device for controlling the luminance of a display unit in a display device according to the related art.

Referring to FIG. 1, an illumination sensor 40 detects peripheral illumination of a display device, and transfers the detected illumination data to a main controller 10. In this case, the illumination sensor 40 communicates with the main controller 10 using an Inter-Integrated Circuit (I2C) protocol. Accordingly, the main controller 10 receives illumination data from the illumination sensor 40 through an I2C interface 15. Next, to control the brightness of the display element 30 according to the peripheral illumination, the main controller 10 converts the illumination data into luminance data and then determines a gamma register value according to the luminance data. Here, there may be 9 gamma register values. The main controller 10 transfers the determined gamma register value to a display driver 20. Accordingly, the display driver 20 drives the display element 30 according to which of the determined 9 gamma register values is provided from the main controller 10 to execute a display function.

In a method for driving a display unit according to the related art as illustrated previously, the main controller 10 should change the gamma register value in the display driver 20 when the luminance changes. Each of the gamma register values is composed of address data and display data. In this case, because the main controller 10 should output a plurality of gamma register values to the display driver 20, a large load is applied thereto. This reduces the processing speed of the main controller 10 and increases current consumption.

### SUMMARY OF THE INVENTION

Aspects of the present invention are to address at least the above-mentioned problems and/or disadvantages and to provide the advantages described below. Accordingly, an aspect of the present invention is to provide a method for controlling the luminance of a display unit by a display controller separately from a main controller in a device including the display unit, the main controller controlling the device, and the display controller displaying the display unit.

In accordance with an aspect of the present invention, an apparatus for displaying and controlling a screen of a portable terminal device is provided. The apparatus includes a sensor for detecting illumination according to peripheral brightness, and a display unit for outputting display data of the portable terminal device, for storing gamma register values corresponding to luminance data, for displaying the display data on a screen, for converting the detected illumination into luminance, and for selecting a gamma register value corresponding to the luminance to control brightness of the screen.

In accordance with another aspect of the present invention, a method for displaying and controlling a screen of a portable terminal device comprising a sensor for detecting illumination according to peripheral brightness and a main controller for outputting display data of the portable terminal device is provided. The method includes converting the detected illumination from the sensor into luminance, selecting a gamma register value corresponding to the luminance from a luminance/gamma register value conversion table, and controlling the screen brightness of a display element with the selected gamma register value.

Exemplary embodiments of the present invention may control the luminance of a display unit by a display controller separately from a main controller in a device including the display unit, the main controller controlling the device, and the display controller displaying the display unit to reduce a load of the main controller and to automatically control the luminance of the display unit with low power and at high speed.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the present invention will be more apparent from the following description taken in conjunction with the accompanying drawings, in which:

FIG. 1 is a block diagram illustrating a configuration of a device with a display unit controlling the luminance of the display unit according to the related art;

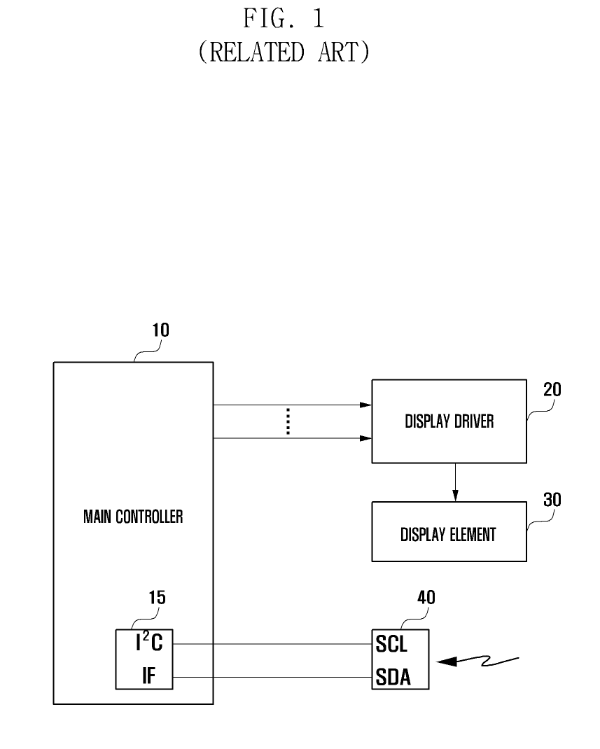

FIG. 2 is a block diagram illustrating a configuration of a device with a display unit for controlling the luminance of the display unit according to an exemplary embodiment of the present invention;

FIG. 3 is a block diagram illustrating a configuration of a device with a display unit for controlling the luminance of the display unit according to an exemplary embodiment of the present invention; and

FIG. 4 is a flowchart illustrating a method for controlling the luminance of a display unit according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention suggest a method for controlling the luminance of a display unit by a display controller separately from a main controller in a device including the display unit, the main controller controlling the device, and the display controller displaying the display unit. To do this, in an exemplary embodiment of the present invention, a display unit stores gamma register values corresponding to a plurality of luminances, detects illumination data according to a peripheral light amount to determine luminance corresponding to the detected illumination data, and selecting gamma register values corresponding to the determined luminance to drive a display element.

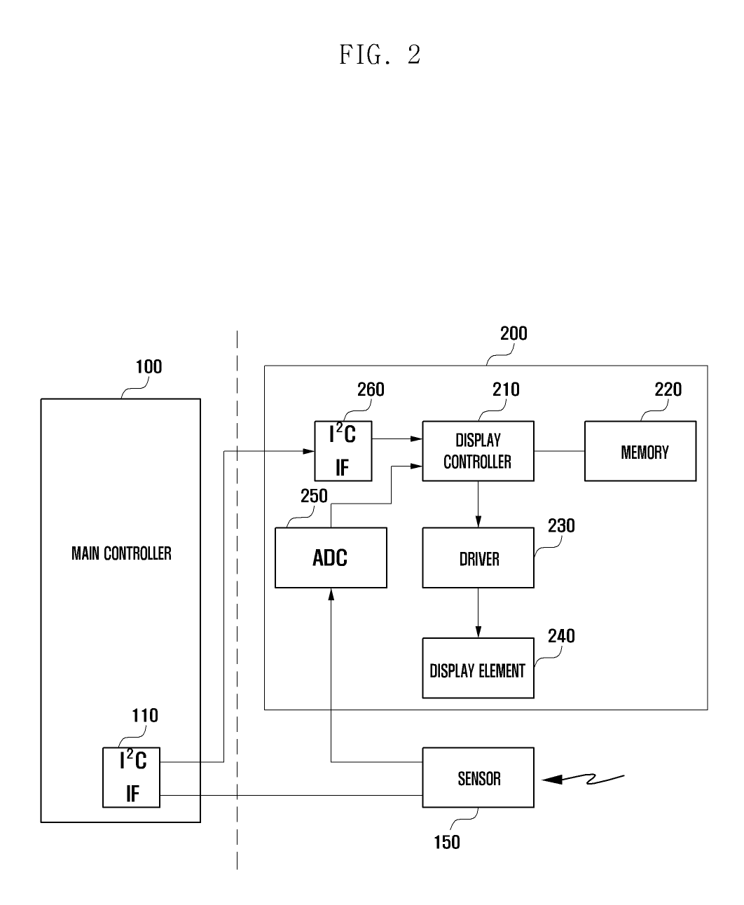

FIG. 2 is a block diagram illustrating a configuration of a device with a display unit for controlling the luminance of the display unit according to an exemplary embodiment of the present invention.

Referring to FIG. 2, a main controller 100 controls an overall operation of a portable terminal device. The main controller 100 also transmits display data created during execution of the operation to a display unit 200. Here, the portable terminal device may include a portable phone, a portable computer, portable data devices, and the like. In this case, the main controller 100 may communicate with the display unit 200 using an I2C protocol. That is, the display data are transmitted to the display unit 200 through an Inter-Integrated Circuit (I2C) interface 110. A sensor 150 detects illumination data according to an amount of peripheral light and provides the detected result to the display unit 200. In this case, the illumination data have different values according to, for example, day, night, morning, or evening. Here, the sensor 150 is an illumination sensor and may be an analog sensor.

The display unit 200 displays display data output from the main controller 100, and automatically controls the brightness of a screen according to illumination data input from the sensor 150.

The display unit 200 includes an Analog to Digital Converter (ADC) 250, an I2C interface 260, a memory 220, a display controller 210, a driver 230, and a display element 240. The ADC 250 converts an analog illumination signal detected by the sensor 150 into a digital signal to generate illumination data. The I2C interface 260 receives display data provided from the main controller 260 in an I2C protocol. The memory 220 stores gamma register values corresponding to a plurality of luminances. It is assumed in an exemplary embodiment of the present invention that the memory 220 stores gamma register values as listed in the following Table 1 to Table 6. Here, Table 1 to Table 6 may be luminance/gamma value conversion tables.

The display controller 210 controls an overall operation of the display unit 200. Further, the display controller 210 determines luminance data based on the illumination data output from the ADC 250, and reads and outputs a gamma register value corresponding to the luminance data from the memory 220. The display controller 210 further outputs the display data provided from the main controller 100 to the driver 230. The driver 230 outputs the display data provided from the display controller 210 to the display element 240, and controls the brightness of the display element 240 according to a gamma register value output from the display controller 210. Here, the display element 240 may be a Liquid Crystal Display (LCD), a Light Emitting Diode (LED), and the like. In an exemplary embodiment of the present invention, the display element 240 may include an Active Matrix Organic Light Emitting Diode (AMOLED).

TABLE 1

| Luminance | Address | Data setting |
|---|---|---|
| 200 | R70h | 2685 |
| | R71h | 2A05 |
| | R72h | 3005 |
| | R73h | 3126 |
| | R74h | 1A19 |
| | R75h | 3E25 |
| | R76h | 1A1A |
| | R77h | 3E21 |
| | R78h | 1717 |

TABLE 2

| Luminance | Address | Data setting |
|---|---|---|
| 175 | R70h | 2485 |
| | R71h | 2805 |
| | R72h | 2D85 |
| | R73h | 2E26 |
| | R74h | 1A1B |
| | R75h | 3F27 |
| | R76h | 1A1B |
| | R77h | 3F22 |
| | R78h | 1719 |

TABLE 3

| Luminance | Address | Data setting |
|---|---|---|
| 150 | R70h | 2305 |
| | R71h | 2685 |
| | R72h | 2B85 |
| | R73h | 2826 |
| | R74h | 1C1A |
| | R75h | 3F27 |
| | R76h | 1C1A |
| | R77h | 3F23 |
| | R78h | 1918 |

TABLE 4

| Luminance | Address | Data setting |
|---|---|---|
| 125 | R70h | 2085 |
| | R71h | 2405 |
| | R72h | 2885 |
| | R73h | 2828 |
| | R74h | 1B1D |
| | R75h | 3F29 |
| | R76h | 1C1C |
| | R77h | 3F25 |
| | R78h | 191A |

TABLE 5

| Luminance | Address | Data setting |
|---|---|---|
| 100 | R70h | 1E85 |
| | R71h | 2185 |
| | R72h | 2605 |
| | R73h | 2828 |
| | R74h | 1D1C |
| | R75h | 3F2A |
| | R76h | 1D1D |
| | R77h | 3F27 |
| | R78h | 1A1A |

TABLE 6

| Luminance | Address | Data setting |
|---|---|---|
| 50 | R70h | 1885 |
| | R71h | 1B05 |
| | R72h | 1E05 |
| | R73h | 2826 |
| | R74h | 201E |
| | R75h | 3F2E |
| | R76h | 201F |
| | R77h | 3F2B |
| | R78h | 1E1D |

The display controller 210 transfers the display data received through the I2C interface 260 to the driver 230, and the driver 230 drives the display element 240 according to the display data to display screen data. Further, the display controller 210 controls display of the screen data and controls the screen brightness of the display element according to peripheral brightness.

The following is a description of an exemplary operation for controlling screen brightness by the display unit 200. The memory 220 stores gamma register values by luminances for controlling the screen brightness as listed in Table 1 to Table 6. The gamma register values are data for controlling the screen brightness of the display element 240 according to the peripheral brightness of the portable terminal device. The sensor 150 detects an amount of light peripheral to the portable terminal device, and generates illumination data according to the detected amount of peripheral light. At this time, the illumination data may have different values according to the peripheral brightness. As an example, an illumination of more than 3000 Lux can be detected at midday in the open air, and an illumination of 100 to 300 Lux can be detected indoors. The illumination signal generated from the sensor 150 is an analog signal. Accordingly, the ADC 250 converts the analog illumination signal into digital illumination data, and the display controller 210 converts the digital illumination data into luminance data.

Here, the illumination/luminance conversion value cd/m² may be obtained by Equation 1.

Cd/m²=x(lux)*Reflecting rate of mirror*Transmittance of screen*Gain of currently used Screen(Toppan,DNP)*0.318(conversion factor from lux to nit) Equation (1)

where, lux denotes an illumination unit, Cd/m² denotes a luminance unit, and nit (nt=cd/m²) denotes a luminance unit.

The illumination/luminance conversion value may be determined in the foregoing manner or may be experimentally measured. The display controller 210 may store the illumination/luminance conversion value in an internal table. Hereinafter, it is assumed that exemplary embodiments of the present invention include an illumination/luminance conversion table. The memory 220 or the display controller 210 may include the illumination/luminance conversion table.

The display controller 210 converts illumination data into luminance data, and reads a gamma register value according to the converted luminance data from the memory 220. The gamma register value may be read from one of Table 1 to Table 6. Accordingly, the display controller 210 outputs the display data received from the main controller 100 to the driver 230, and the driver 230 controls the screen brightness of the display element 240 according to the gamma register value. The screen brightness changes according to the amount of peripheral light, and accordingly the display unit 200 automatically controls the brightness of a screen displayed according the amount of peripheral light.

Further, the display unit 200 may control the screen brightness under the control of a user. In this case, the user may select the screen brightness by an input unit (not shown) of the portable terminal device. When the screen brightness is selected, the main controller 100 converts the selected screen brightness into luminance data processed by the display unit 200 and outputs the luminance data to the display unit 200 through the I2C interface 110. The display controller 210 receives the luminance data through the I2C interface 260, selects a gamma register value corresponding to the luminance data provided from the main controller 100 from the memory 220, and then performs the foregoing operation. As a result, the display unit 200 may drive the display element 240 with the brightness desired by the user.

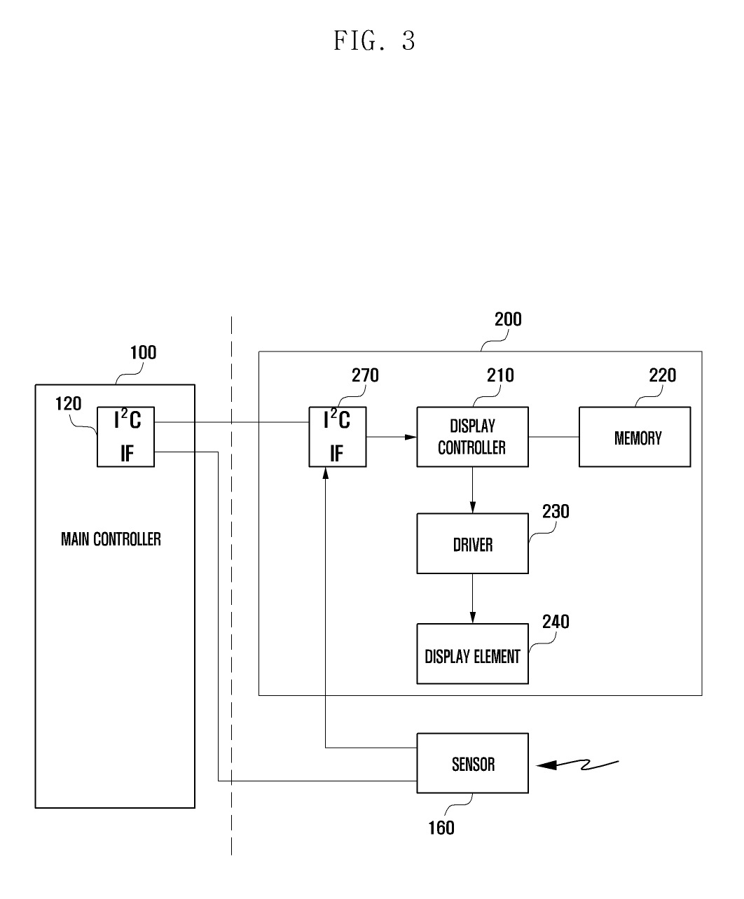

FIG. 3 is a block diagram illustrating a configuration of a device with a display unit for controlling the luminance of the display unit according to an exemplary embodiment of the present invention.

Referring to FIG. 3, a main controller 100 controls an overall operation of a portable terminal device. The main controller 100 also transmits display data created during execution of the operation to a display unit 200. Here, the portable terminal device may include a portable phone, a portable computer, a portable data device, and the like. In this case, the main controller 100 may communicate with the display unit 200 in an I2C protocol, and the display data are transmitted to the display unit 200 through an I2C interface 120. A sensor 160 detects illumination data according to an amount of light peripheral to the portable terminal device and provides the detected illumination data to the display unit 200. Here, the sensor 160 is an illumination sensor and may be a digital sensor.

The display unit 200 displays display data output from the main controller 100, and automatically controls the brightness of a screen according to illumination data input from the sensor 160. The display unit 200 includes an I2C interface 270, a memory 220, a display controller 210, a driver 230, and a display element 240. The I2C interface 270 receives illumination data output from the sensor 160 and/or display data provided from the main controller 100 in an I2C protocol. The memory 220 stores gamma register values corresponding to a plurality of luminances. It is assumed in an exemplary embodiment of the present invention that the memory 220 stores gamma register values as listed in Table 1 to Table 6. The display controller 210 controls an overall operation of the display unit 200. Further, the display controller 210 determines luminance data based on the illumination data output from the I2C interface 270, and reads and outputs a gamma register value corresponding to the luminance data from the memory 220. The display controller 210 further outputs the display data provided from the main controller 100 to the driver 230. The driver 230 outputs the display data provided from the display controller 210 to the display element 240, and controls the brightness of the display element 240 according to a gamma register value output from the display controller 210. Here, the display element 240 may be an LCD, an LED, an AMOLED, and the like.

Referring to FIG. 3, the sensor 160 is a digital sensor, and communicates with the display unit 200 using an I2C protocol. The sensor 160 detects illumination according to an amount of peripheral light, converts the detected illumination into digital data, and output the digital data to the display unit 200 using an I2C protocol. Accordingly, an I2C interface 207 of the display unit 200 outputs the illumination data detected by the sensor 160 to the display controller 210. A next operation is performed in substantially the same manner as described with reference to FIG. 2 above and will not be described again for convenience.

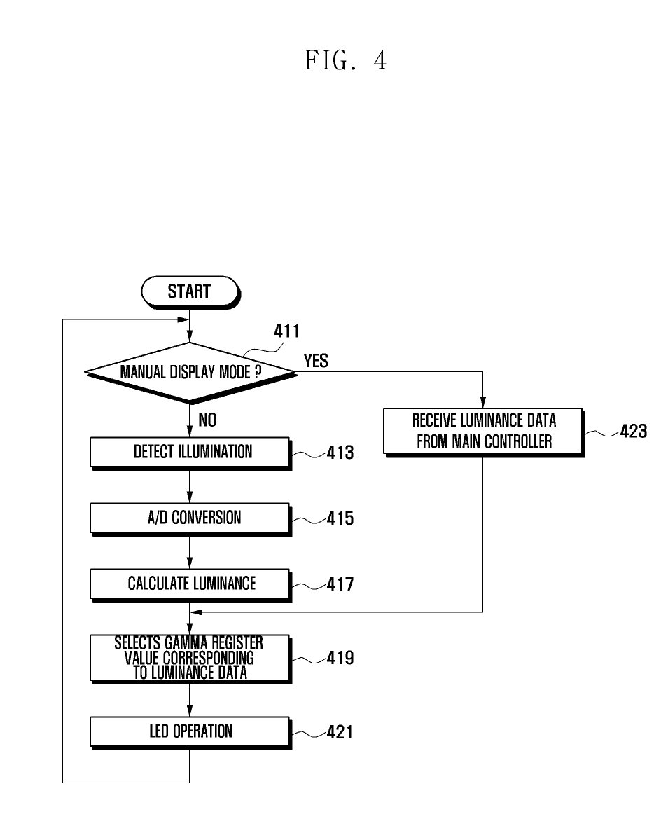

FIG. 4 is a flowchart illustrating a method for controlling the luminance of a display unit according to an exemplary embodiment of the present invention.

If a display controller receives illumination data from a sensor, it controls screen brightness in an automatic mode. If the display controller receives luminance data (or illumination data) from a main controller, it controls the screen brightness in a manual mode. That is, the display unit may automatically control screen brightness according to the illumination data received from the sensor, or manually control the screen brightness according to a request of brightness designated from the user. In this case, the display unit includes a display controller, and the display controller controls a mode of the display unit under the control of the main controller of the portable terminal device. The main controller may set a display mode of the display unit through an input unit. In this case, the display controller may display an automatic display mode or a manual display mode on a display element under the control of the main controller. Further, if the user selects the automatic display mode, the main controller transfers it to the display unit through an I2C interface, and the display controller receives it through the I2C interface to sense the automatic display mode. When the manual display mode is selected, the main controller reports it to the display controller in the foregoing manner. The display controller detects it and may display screen brightness (luminance or illumination) data capable of being displayed in a manual display mode on the display element and a menu to brightness level (day, night, morning). Subsequently, if a user selects optional screen brightness, the main controller transfers it to the display unit, and the display controller may control the display element with screen brightness selected by the user.

Referring to FIG. 4, the display controller determines if the manual display mode is selected in step 411. If it is determined in step 411 that the manual display mode is not selected, that is that the automatic display mode is selected, the sensor detects illumination in step 413 and the display controller converts an analog illumination signal received from a sensor into digital illumination data in step 415. Here, when the sensor is a digital illumination sensor, step 415 may be omitted. Next, the display controller converts the detected digital illumination data into a luminance value in step 417. In this case, the illumination data may be peripheral brightness information as described earlier. Subsequently, the display unit selects a gamma register value corresponding to the luminance data from the memory in step 419, and controls the screen brightness of the display element based on the selected gamma register value in step 421.

However, if a manual display mode is selected at step 411, the display controller receives luminance data indicating the manually selected brightness of a screen from the main controller in step 423, and the process goes to step 419 and performs the foregoing operations. At this time, the main controller may not transmit luminance data but may output data for controlling screen brightness as illumination data. In this case, the display unit may convert illumination data received from the main controller into luminance data and perform the foregoing operation.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. An apparatus for displaying and controlling a screen of a portable terminal device, the apparatus comprising:
a sensor for detecting illumination according to peripheral brightness; and
a display unit for outputting display data of the portable terminal device, for storing gamma register values corresponding to luminance data, for displaying the display data on a screen, for converting the detected illumination into luminance, and for selecting a gamma register value corresponding to the luminance to control brightness of the screen.

2. The apparatus of claim 1, wherein the display unit comprises:
a main controller for outputting the display data of the portable terminal.

3. The apparatus of claim 2, wherein the display unit comprises:
a display element;
a memory for storing the gamma register values corresponding to luminance;
a display controller for converting the detected illumination received from the sensor into luminance, and for selecting and outputting gamma register values corresponding to the converted luminance; and
a driver for outputting the selected gamma register values on the display element to control the screen brightness of the display element.

4. The apparatus of claim 3, wherein the display controller comprises an illumination/luminance conversion table, and converts the detected illumination into luminance.

5. The apparatus of claim 4, wherein the display element comprises an active matrix organic light-emitting diode.

6. The apparatus of claim 5, wherein the sensor comprises an analog illumination sensor, and wherein the display unit further comprises a converter for converting an output of the sensor into digital illumination data and for outputting the converted digital illumination data to the display controller.

7. The apparatus of claim 5, wherein the sensor comprises a digital illumination sensor, and wherein the display unit further comprises an Inter-Integrated Circuit (I2C) interface for receiving and outputting illumination data output from the sensor using an I2C protocol to the display controller.

8. A method for displaying and controlling a screen of a portable terminal device including a sensor for detecting illumination according to peripheral brightness and a main controller for outputting display data of the portable terminal device, the method comprising:
converting the detected illumination from the sensor into luminance;
selecting a gamma register value corresponding to the luminance from a luminance/gamma register value conversion table; and
controlling the screen brightness of a display element with the selected gamma register value.

9. The method of claim 8, further comprising selecting a manual display mode,
wherein the selecting of the manual display mode comprises:
displaying a screen brightness menu on the display element when the manual display mode is selected;
selecting luminance corresponding to screen brightness of a selected menu;
storing a gamma register value corresponding to the luminance and selecting a gamma register value corresponding to the luminance from a memory; and
controlling the screen brightness of the display element with the selected gamma register value.

10. The method of claim 9, wherein the converting of the detected illumination into luminance comprises selecting luminance corresponding to the detected illumination from an illumination/luminance conversion table.

11. The method of claim 10, wherein the display element comprises an active matrix organic light-emitting diode.

12. The method of claim 8, wherein the converting of the detected illumination into luminance comprises converting the detected illumination into digital illumination data.

13. The method of claim 8, wherein the sensor comprises a digital illumination sensor that outputs the illumination data using an Inter-Integrated Circuit (I2C) protocol.
